(19) United States
(12) Patent Application Publication
(10) Pub. No.: US 2004/0133877 A1
(43) Pub. Date: Jul. 8, 2004

(54) Outline-processor taking program structure into account

(75) Inventor: Hideharu Mochizuki, Minato-ku (JP)

Correspondence Address: NIXON PEABODY, LLP, 401 9TH STREET, NW, SUITE 900, WASINGTON, DC, 20004-2128, US

(73) Assignee: Oki Electric Industry Co., Ltd., Tokyo (JP)

(21) Appl. No.: 10/670,350

(22) Filed: Sep. 26, 2003

Related U.S. Application Data
(60) Provisional application No. 60/413,769, filed on Sep. 27, 2002.

(51) Int. Cl. G06F 9/44

(52) U.S. Cl. 717/114; 717/120; 717/107

(57) ABSTRACT

An outline-processor that surrounds each program constituted from a plurality of programs by a respective frame having diagram-displays that connect the frames by a line, such that if the inside of the frame is clicked by a mouse, a source of the program therein is outline-displayed. Diagram-displays display respective arguments of the programs in the vicinity of the frames of the programs and display frame lines of the program thick before expansion and thin after expansion to change the thicknesses of the frame lines of the program before and after expansion. Further, when the plurality of programs are outline-displayed in a plural number, a newest outline-display is displayed in front.

### BACKGROUND OF THE INVENTION

1. Field of the Invention

The present invention relates to a text editor having a hierarchical structure and taking into account a program structure in the C language or the like.

2. Related Art

In recent years, although text editors having various functions have appeared, some of them not only are boards to write sentences into, but also have hierarchical structures similar to Windows Explorer of Windows by Microsoft Corporation in USA. In the file systems of Windows, folders are in a hierarchical structure, and associated files are packed therein for the convenience of users. Hierarchization of text editors is just similar to the arrangement of putting a series of sentences instead of the names of the folders. Such hierarchized text editors are greatly linked to how users use the text editors, and referred to as idea-processors, outline-processors, or outliners in abbreviation.

On idea-processors, the convenience by their hierarchical structure in writing down ideas coming one after another is paid attention to. What is important when an idea comes is to write it down while it is fresh, and it is not important whether or not the logic is in order. The idea is written down in a line at the moment, and in moving the line to a logically ordered place, an idea-processor allows easy moving of it by an interface such as mouse.

In an outline-processor, the ‘hierarchical’ structure thereof can be allocated to the arrangement of a composition, for example. If the composition is a script, the arrangement is fixed to some extent in such a manner that it has a title, a table of contents, a prologue, contents showing introduction, development, turn and conclusion, and an epilogue or comments at the end. In the outline-processor, functions allowing free editing of such an arrangement of a composition (outline) is paid attention to. A tree structure similar to a folder is highly visual and makes editing thereof easy. Whatever the contents of the composition may be, as long as it has a structure, the outline-processor can be an auxiliary tool for writing and the like.

FIGS. 3 and 4 are explanatory diagrams illustrating what kind of functions a conventional outline-processor has, and display examples of description thereof. FIG. 3 is an example of description by outline-display, focused on description method of sentences. An ‘outline’ is virtually a range surrounded by frame lines, and is referred to as ‘a block’, in the present embodiment, in the range of which contents are described. In FIG. 3, the symbol ‘+’ in a rectangular means that the block thereof has a nesting structure, and a hierarchy of the block is present thereunder but is not displayed currently. Similarly, the symbol ‘−’ in a rectangular means that there is a hierarchy of blocks under the block and they are all expanded. The case of no symbol in a rectangular (hereinafter referred to as ‘icon’) means there is no hierarchy of blocks under the block. This display method has a hierarchical structure very similar to Windows Explorer. Key inputs and mouse operations allow easy change and moving in hierarchy, which is convenient for restructuring of sentences and the like. Possible operations are shown in the figure for reference.

FIG. 4 is an example of description by diagram-display, in which sentences and the like are visually located. In the figure, the hierarchical structure is indicated by lines connecting the frames, and the lower the location, the level of the hierarchy deeper.

Generally, when a programmer describes a program source, he/she usually uses some editor. If he/she uses the above described outline-processor as the editor, it is very user-friendly. The prime reason is that the hierarchical structure of programs and the above described hierarchical structure of the outline-processor harmonize with each other well. In a usual program, many subroutines are made under a main function so that each subroutine takes its individual job. Accordingly, the relationships of dependence between functions can be described in the above described hierarchical structure of the outline-processor. Further, the hierarchical structure can be used to pack and describe the list of variables, arguments to be used in functions, definitions of constants, and the like.

FIG. 5 is an example displaying a source list in the C language by a conventional outline-processor. The entire hierarchical structure is expanded to show all the contents. The producer of the source in the C language needs to input a source in the input blocks in all the hierarchies. It can be said that the conventional outline-processor does not necessarily have functions to assist or aid the producer of the source.

On the other hand, a simple editor attached to a product such as ‘Visual C⁺⁺’, by Microsoft Corporation in USA, for example, limits a source program produced thereby to be written in the C language or C⁺⁺ language, and thus has functions taking the program language into account. Comment lines such as ‘write a function here’, for example, are written here and there to support the producers of sources in C⁺⁺ language. Also, in a dedicated editor in the case of describing in an HTML (Hyper Text Markup Language) language attached to a product such as ‘homepage builder’ by IBM Japan, an interpreter colors various tags and reserved words such as, ‘content’, ‘name’, and ‘href’, for example, in designated colors simultaneously with describing them. Such an editor or the like in collaboration with a program language not only makes the job of producing source programs easy, but also makes the produced source programs look clear.

### SUMMARY OF THE INVENTION

The prime object of the invention is to provide an outline-processor that uses the hierarchical structure of outline-processors, adapts to the C language or C⁺⁺ language, and thus has functions to assist or aid the producers of sources.

To attain the above object, in an C or C⁺⁺ language environment, the invention provides an outline-processor in which outline-display and diagram-display are arranged in one body and which adds or constructs fixed sentences in real-time, following describing in the C language or the like, to assist or aid the producers of sources.

### BRIEF DESCRIPTION OF THE DRAWINGS

FIG. 1 shows a first embodiment of the invention and an example displaying a source list in the C language by an outline-processor according to the invention;

FIG. 2 is an example displaying the case of plural outline-displays in the first embodiment of the invention;

FIG. 3 is an explanatory diagram illustrating what kind of functions a conventional outline-processor has and an example of description by outline-display focused on a description method of sentences;

FIG. 4 is an explanatory diagram illustrating what kind of functions a conventional outline-processor has and an example of description by diagram-display, in which sentences and the like are visually located;

FIG. 5 is an example displaying a source list in the C language by a conventional outline-processor; and

FIG. 6 discloses a plurality of embodiments in which, if the producer of a source inputs reserved words in the C language or the like, the outline-processor automatically produces the fixed sentences to assist the producer.

### DESCRIPTION OF THE PREFERRED EMBODIMENTS OF THE INVENTION

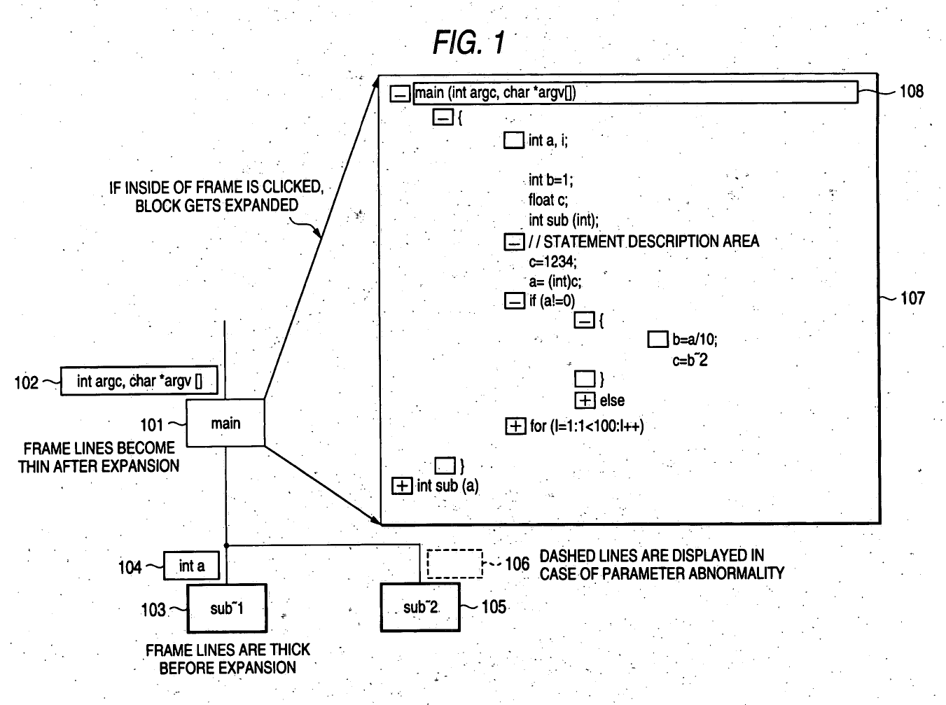

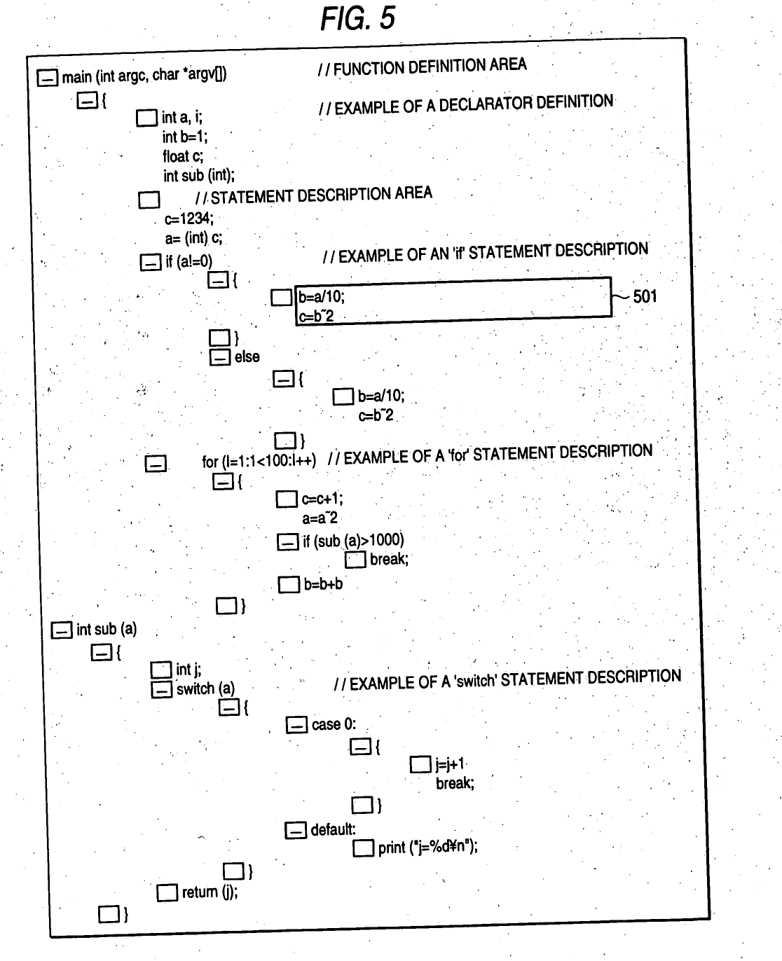

A first embodiment of the invention will be described below in detail. FIG. 1 shows a first embodiment according to the invention and an example displaying the source list in the C language in FIG. 5 by an outline-processor according to the invention.

One thing that is different in this embodiment from conventional outline-processors is that outline-display and diagram-display are arranged in one body in the outline-processor. In FIG. 1, a main program (101) displayed as ‘main’ in a rectangular frame has a structure, wherein the source (107) thereof is expanded if the inside of the frame is double clicked. The main program (101) is displayed by a diagram-display, and the expanded source. (107) is displayed by an outline-display. The outline-processor is different from a conventional outline-processor in that both displays are displayed on the same editing screen. In this embodiment of the invention, the frame lines of the program after expansion of the outline-display are displayed thin, and the frame lines before expansion are displayed thick. This is devised to make the currently expanded program clear in diagram display. The expanded source 107 is in the edit mode by default, and the leading block thereof is surrounded by frame lines to show clearly that it is the block 108 that is currently edited.

Another thing that is different in this embodiment from a conventional outline-processor is that an argument is displayed in another frame in the vicinity of a program in diagram-display. For example, on the left above the main program 101, the argument 102 thereof is displayed. This works to make using-relationships between functions clear in diagram display. In this embodiment, a subroutine ‘sub⁻1’ 103 is called from the main program displayed as ‘main’, wherein the argument 104 of the subroutine is displayed clearly, which makes the using state of the subroutine clear.

The dependence relationships between functions are displayed by lines or broken lines connecting to each programs. In this embodiment, since the main program 101 displayed as ‘main’ calls the subroutine ‘sub⁻1’ 103, the frame of the subroutine ‘sub⁻1’ 103 is located lower to the frame of the main program 101, and the frames are connected to each other by a line. In this embodiment, the main program 101 calls another subroutine ‘sub⁻2’ 105, and they are connected to each other by a broken line.

This embodiment also deals with the case in detail that a source program is in the process of production and the relationships between functions are not yet clear. The argument frame 106 of the subroutine ‘sub⁻2’ 105 is displayed by dotted lines. This shows that the contents of the subroutine ‘sub⁻²’ 105 are not yet completed, or the argument is abnormal because the main program 101 has not called the subroutine properly. If the type of the argument in calling the subroutine from the main program 101 and the type of the argument of the subroutine ‘sub⁻2’ 105 do not accord, the frame of the argument 106 of the subroutine is displayed by dotted lines.

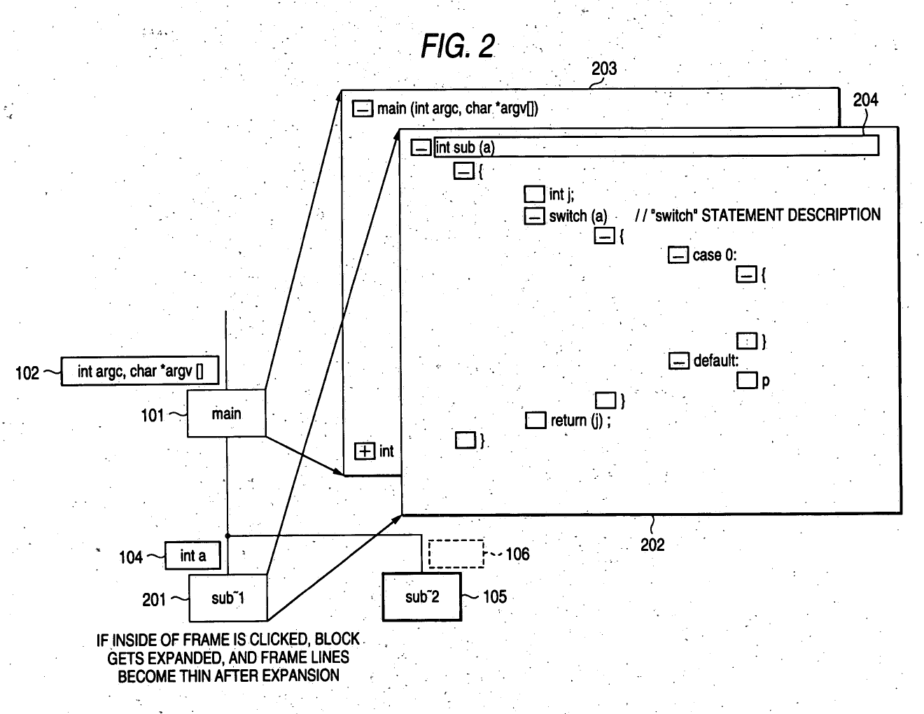

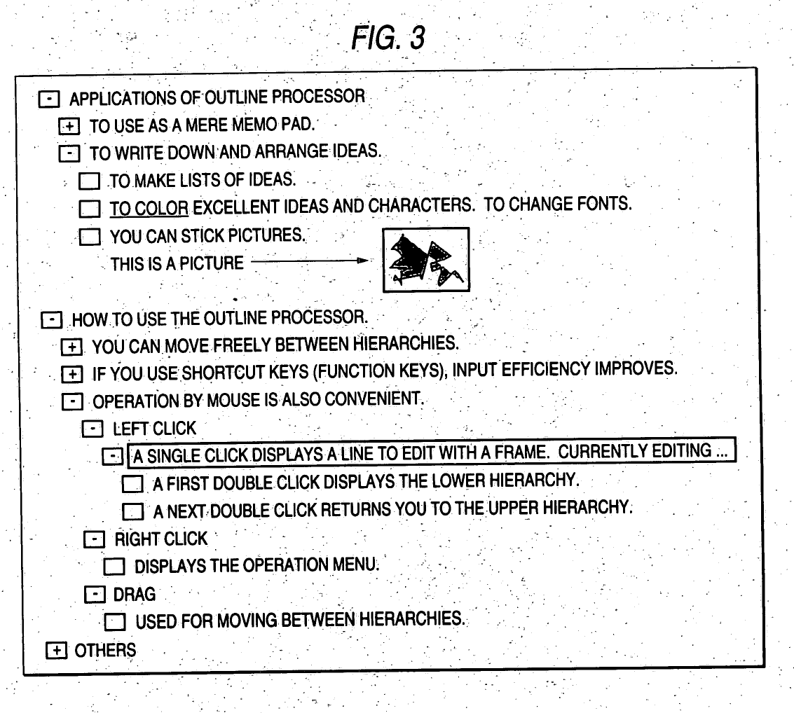

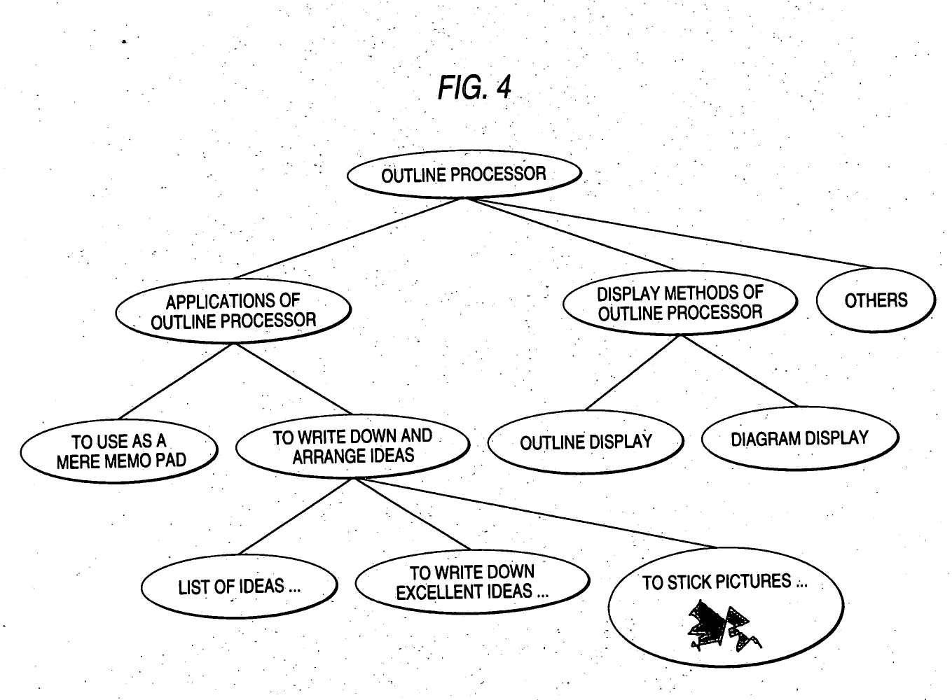

FIG. 2 is an example of displaying the case of plural outline-displays in the first embodiment of the invention. In FIG. 2, if the inside of the frame of the subroutine ‘sub⁻1’ 103 in FIG. 1 is double clicked, a source 202 thereof currently edited is outline-displayed, and thereafter the display frame of the subroutine ‘sub⁻1’ 201 is displayed with the lines thereof thin.

In the case of plural outline-displays, the outline-display 204 lastly expanded is displayed in the front, and the outline-display 203 previously expanded is put backward and colored gray in this embodiment. This display method is similar to the Window of the Windows described above. The expanded source is in the edit mode by default, and the leading block thereof is surrounded by frame lines to show clearly that the leading block is the block 204 currently edited.

Another thing which is different in this embodiment from a conventional outline-processor is that editing which takes a program structure of the C language or the like into account is achieved in outline-display. This means that a kind of interpreter functions to realize an intelligent outline-processor. In this embodiment, since the C language or the like has a plurality of reserved words, which are fixed sentences according to grammar, if the producer of a source inputs the reserved words, the outline-processor automatically produces the fixed sentences to aid the producer.

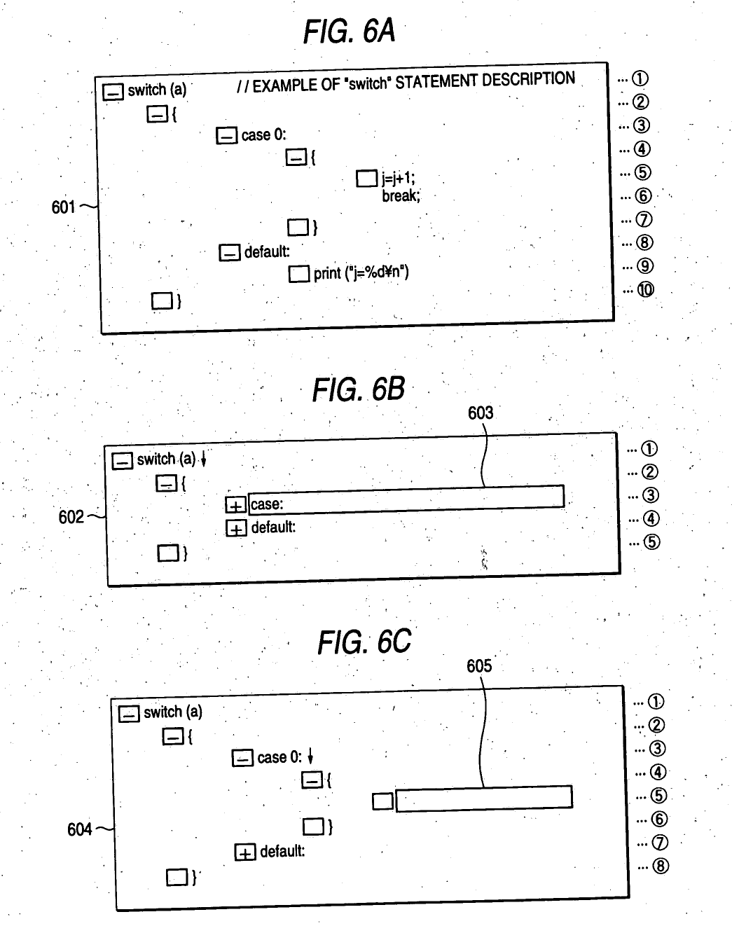

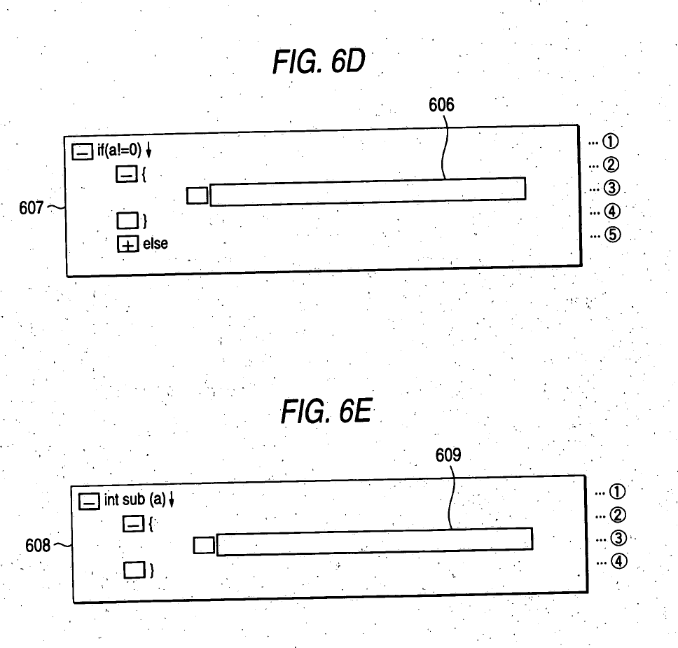

In FIGS. 6A to 6E, a plurality of such embodiments are disclosed. FIG. 6A is a display example 601 of a switch statement, and is a complete figure when the producer of the source has input this source. As shown in FIG. 6B, if the producer of the source inputs ‘switch (a)’ as (i) in the display example 602 of the source of the switch statement, the outline processor takes into account that this word is a switch statement in the C language and automatically produce (ii), (iii), (iv), and (v). The symbol ‘↓’ in the figure means inserting of a return (0x0A) by the enter key. The actions of the outline-processors are as follows. First, an indent is inserted and the symbol ‘{’ is inserted. Second, in the front of the switch statement and in the front of the symbol ‘{’, a mark (the above described icon) of the hierarchical structure having the symbol ‘−’ is inserted. Third, an indent is input twice, a block 603 currently edited having the icon with the symbol ‘+’ in the front thereof is displayed, and a tentative construction ‘case:’ is displayed in the block. Fourth, an indent is input twice, a block having an icon with the symbol ‘+’ in the front thereof is displayed, and a tentative structure ‘default:’ is displayed in the block. Fifth, an indent is inserted, and an icon is inserted in the front of the symbol ‘}’. It should be noticed herein that the icon of the case statement and the icon of the default statement are filled with the symbol ‘+’, and things other than the block which the producer of the source is paying attention to are shielded as much as possible. This is carried out so that the display looks clear for the convenience of the producer of the source. As to whether or not the tentative structure ‘default:’ is to be inserted can be set as option.

FIG. 6C is a display example 604 at the time the producing of the switch statement has further proceeded from FIG. 6B. In (iii) in FIG. 6C, if ‘case 0:’ is input, the outline processor takes into account that this word is a detailed structure of the switch statement and automatically produces (iv), (v), and (vi). This is the expanded state of (iii) in FIG. 6B. The actions of the outline-processor are similar to the above described process, and the block 605 currently edited turns to (v).

FIG. 6D is a production example of an if statement. If the producer of the source inputs ‘if(a!=0)’ as in (i) in the display example 606 of the source of an if statement, the outline-processor takes into account that this word is an if statement of the C language and automatically produces (ii), (iii) (iv), and (v)., while the block 607 currently edited turns to (iii). In this if statement, an option is set to add an else statement. The icon of the else statement is filled with the symbol ‘+’ here, and blocks other than the block which the producer of the source pay attention to are shielded. This is carried out so that the display looks clear for the convenience of the producer of the source.

FIG. 6E is a production example of a function statement. In the display example 608 of a function, if the producer of the source inputs ‘int sub (a)’ as in (i), the outline processor takes into account that this word is a function statement in the C language, and automatically produces (ii), (iii), and (iv), while the block 609 currently edited turns to (iii). If this function is a subroutine, an option to insert a return statement can be set. For example, a block such as ‘return( );’is added, and an icon filled with the symbol ‘+’ is displayed in the front thereof.

As described above, if the producer of a source inputs reserved words in the C language or the like, an outline-processor according to the invention automatically produces fixed sentences to effectively aid producing of the source, which contributes to reduction in the labor of the producer of the source.

Needless to say, outline-processors of the invention have functions similar to those of conventional outline-processors. Moving and copying of blocks can be carried out maintaining the hierarchy. Further, an arbitrary position can be designated as the position to move or copy a block. In moving or the like, if an icon is dragged, the hierarchy can be maintained, but if the frame of the block currently edited is dragged, the content of the edited block is moved.

Embodiments of the invention do not reduce the advantages of conventional outline-processors. That is, sources constructed by outline-processors are easier to see and more understandable compared to sources produced by flat texts. Particularly, if programs are arranged in unit of a function, the understandability and the readability thereof greatly improves.

According to the first embodiment of the invention, by constructing an outline-processor in which outline-display and diagram-display are arranged into one body, an environment for production of sources which are much more visual and looks clearer than a conventional outline-processor has been provided. Also, by constructing an intelligent outline-processor which effectively aids production of sources in the C language or the like, the invention has contributed to further reduction in the labor of the producers of sources.

What is claimed is:

1. An outline-processor that surrounds each of programs constituted from plural programs by a respective frame (101, 103, or 105) and has diagram-displays that connect the frames by a line, wherein if the inside of the frame (101) is clicked by mouse, a source (107) of the program therein is outline displayed.

2. The outline-processor according to claim 1, having diagram-displays (102 and 104) that display respective arguments of the programs in the vicinity of the frames (101 and 103) of the programs.

3. The outline-processor according to claim 1, displaying frame lines of the program thick before expansion and thin after expansion to change the thicknesses of the frame lines of the program before and after expansion.

4. The outline-processor according to claim 1, wherein when the plurality of programs is outline-displayed (203 and 204) in a plural number, a newest outline-display (204) is displayed in front.
